(19) United States
(12) Patent Application Publication
(10) Pub. No.: US 2012/0085696 A1
(43) Pub. Date: Apr. 12, 2012

(54) FILTER ELEMENT AND METHOD FOR ITS PRODUCTION

(75) Inventor: Ulrich Schloer, Darmstadt (DE)

(73) Assignee: CARL FREUDENBERG KG, Weinheim (DE)

(21) Appl. No.: 13/253,145

(22) Filed: Oct. 5, 2011

(30) Foreign Application Priority Data
Oct. 11, 2010 (DE) 10 2010 047 894.6

(51) Int. Cl. B01D 29/07; B31B 1/14

(52) U.S. Cl. 210/493.5; 493/340

(57) ABSTRACT

A filter element includes a pleated filter medium including pleat valleys and pleat walls. The filter medium has a base body including a first flank and a first plastic reinforcement joined to the first flank of the pleated filter medium and accommodating the pleat valleys and pleat walls of the filter medium.

### CROSS REFERENCE TO RELATED APPLICATIONS

This application claims priority to German Patent Application No. DE 10 2010 047 894.6, filed Oct. 11, 2010, which is hereby incorporated by reference herein in its entirety.

### FIELD

The invention relates to a filter element.

### BACKGROUND

European patent EP 1 304 244 B1 describes filter elements having a trapezoidal filter body. It is comprised of four flanks that are oriented orthogonally relative to each other as well as a fifth slanted flank. This fifth slanted flank opens into two flanks, each forming an angle that differs from a right angle. Trapezoidal filter elements of the above-mentioned type have this characteristic shape so that they can be inserted precisely into matching filter housings. Because of their slanted shape, however, the described filter elements are laborious to produce and give rise to a considerable amount of cutting waste. The slanted side normally faces the filter housing. In order to avoid leaks, foam seals are often attached onto the slanted side.

A drawback here is that the foam seal is attached onto relatively unstable flanks of the filter element. As a result, leaks cannot be ruled out.

It is likewise a known procedure to attach foam seals to rectangular filter elements having four flanks that are oriented orthogonally relative to each other. Here, too, leakage problems can occur.

In addition some procedures injection-mold a plastic reinforcement onto one or more flanks of a rectangular filter element. This, however, involves laborious processes that call for injection molds. In particular, the filter elements are placed into the injection molds, positioned correctly and then carefully joined with plastic. These methods are associated with high costs.

### SUMMARY

An aspect of the invention is to provide a filter element that, after being produced without any problems and inexpensively, ensures a tight seat in a filter housing and exhibits a mechanically stable structure.

In an embodiment, the present invention provides a filter element including a pleated filter medium including pleat valleys and pleat walls. The filter medium has a base body including a first flank and a first plastic reinforcement joined to the first flank of the pleated filter medium and accommodating the pleat valleys and pleat walls of the filter medium.

### BRIEF DESCRIPTION OF THE DRAWINGS

Exemplary embodiments of the present invention are described in more detail below with respect to the drawings, in which:

FIG. 1 shows a perspective view of a rectangular sheet of pleated filter medium from which two filter elements with slanted sides are produced;

FIG. 2 shows a top view of the sheet and the filter elements according to FIG. 1;

FIG. 3 shows a sectional view of the sectional line A-A according to FIG. 2;

FIG. 4 shows a view of the circular section B according to FIG. 3;

FIG. 5 shows a sectional view of the sectional line C-C according to FIG. 2;

FIG. 6 shows a perspective view of a second plastic reinforcement;

FIG. 7 shows a perspective view of two connected first plastic reinforcements; and

FIG. 8 shows a perspective view of a second plastic reinforcement.

### DETAILED DESCRIPTION

It has been recognized according to embodiments of the invention that it is easy to produce a filter element, comprising a pleated filter medium that has pleat valleys and pleat walls, wherein the filter medium consists of a base body, wherein the base body has a first flank that is reinforced by a first plastic reinforcement, and wherein the first flank is joined to a first plastic reinforcement that accommodates pleat valleys and pleat walls of the filter medium. Concretely, speaking, it has been recognized that a plastic reinforcement with a two-part structure permits the filter element to be produced in a continuous manufacturing process. The plastic reinforcement can be simply placed onto a continuous sheet of a pleated filter medium and then be fused or glued to it. The finished filter element can then be separated from the sheet by cutting. A blade can easily be guided along the first plastic reinforcement or along another plastic reinforcement. The plastic reinforcement stabilizes the filter medium. Hence, a filter element is put forward that, after being produced without any problems and inexpensively, ensures a tight seat in a filter housing and that exhibits a mechanically stable structure.

Consequently, the invention provides a filter element that, after being produced without any problems and inexpensively, ensures a tight seat in a filter housing and exhibits a mechanically stable structure.

The first plastic reinforcement can be configured in such a way that the pleat valleys and the pleat walls fit into it. As a result, the plastic reinforcement can be easily placed onto a pleated filter medium and, at the same time, affixed there.

Before this backdrop, the first plastic reinforcement can consist of two inserts, namely, a first insert and a second insert, which accommodate the pleat valleys and the pleat walls between them with a positive fit. In this manner, the pleats can be clamped between the inserts, thus establishing a fluid-tight connection between the pleat walls and the plastic reinforcement. Moreover, it is conceivable to create an integral material bond between the pleat walls and the first plastic reinforcement by means of fusing, melting or gluing.

A second plastic reinforcement can be provided that reinforces a second flank that is at a distance from the first flank. In this manner, the filter element can be reinforced on two sides that are opposite from each other and can be provided with cover elements.

The second plastic reinforcement can consist of two inserts, namely, a third insert and a fourth insert, which accommodate the pleat valleys and the pleat walls between them with a positive fit. As a result, the pleats can be clamped between the inserts, thus establishing a fluid-tight connection between the pleat walls and the plastic reinforcement. Moreover, it is conceivable to create an integral material bond between the pleat walls and the first plastic reinforcement by means of fusing, melting or gluing.

The filter medium can consist of a base body having five flanks, the four flanks of the base body being oriented orthogonally relative to each other, wherein the first flank opens up into two of the other flanks and, together with these two flanks, encloses an angle that differs from a right angle, and wherein the first flank and one of the flanks into which it opens up are joined to the first plastic reinforcement. Such a filter element, also referred to as a trapezoidal filter element, is adapted in a special way to the filter housing into which it is inserted. Trapezoidal filter elements of the above-mentioned type have this characteristic shape so that they can be inserted precisely into matching filter housings. Because of their slanted shape, however, the described filter elements are laborious to produce and give rise to a considerable amount of cutting waste. The slanted side normally faces the filter housing. In order to avoid leaks, foam seals are often attached to the slanted side. A drawback here is that the slanted side is relatively unstable due to a cutting process. Consequently, leaks cannot be ruled out. The drawbacks of such procedures are overcome by the first plastic reinforcements described here. In particular, the slanted side is stabilized.

Before this backdrop, the first plastic reinforcement can have a section that is parallel to a second flank of the base body, and a section that, together with the second flank, encloses an angle, preferably an acute angle. A trapezoidal filter element can be easily cut from a sheet of a pleated filter medium by means of a blade that is guided along such a plastic reinforcement.

A sealing device can be provided on one flank and configured in one piece with the filter element in such a manner that the filter element can be inserted into a filter housing, together with the sealing device, as a unit. Here, it is concretely conceivable for the sealing device to cover an opening of a filter housing. This greatly simplifies the installation of the filter element.

Side strips made of a nonwoven can be arranged on the flanks that are not provided with a plastic reinforcement. These side strips made of nonwoven stabilize the filter medium. Here, the filter medium is preferably made of nonwoven.

A method for the production of a filter element of the type described here can comprise the following steps:
providing a rectangular pleated filter medium with filter walls and filter valleys,
inserting a first insert and a second insert onto opposite sides of the filter medium, wherein said inserts accommodate the pleat valleys and the pleat walls between them with a positive fit,
fusing the inserts to the filter medium and cutting the filter medium that has been fused to the inserts away from the rest of the rectangular filter medium.

This method provides a way of making a filter element that, after being produced without any problems and inexpensively, ensures a tight seat in a filter housing and exhibits a mechanically stable structure.

Before this backdrop, a method for the production of a trapezoidal filter element can comprise the following steps:
providing a rectangular pleated filter medium with filter walls and filter valleys,
inserting a first insert and a second insert onto opposite sides of the filter medium, wherein said inserts have a section that is parallel to the pleat walls and a section that is slanted with respect to the pleat walls, and wherein said inserts accommodate the pleat valleys and the pleat walls between them with a positive fit,
fusing the inserts to the filter medium and cutting the filter medium that has been fused to the inserts away from the rest of the rectangular filter medium. In this manner, a trapezoidal filter medium can be produced inexpensively and with a stable design.

The filter medium of the filter elements described here can be made of a nonwoven. Nonwovens have a good filtering effect, and their density and porosity can be selected without any problem. Moreover, nonwovens made of synthetic fibers can be easily fused to plastic reinforcements.

The filter medium can contain adsorbing and/or absorbing media. In this manner, the filter element can be used as a combination filter, especially in air-conditioning systems or for filtering the air in the interior of vehicles.

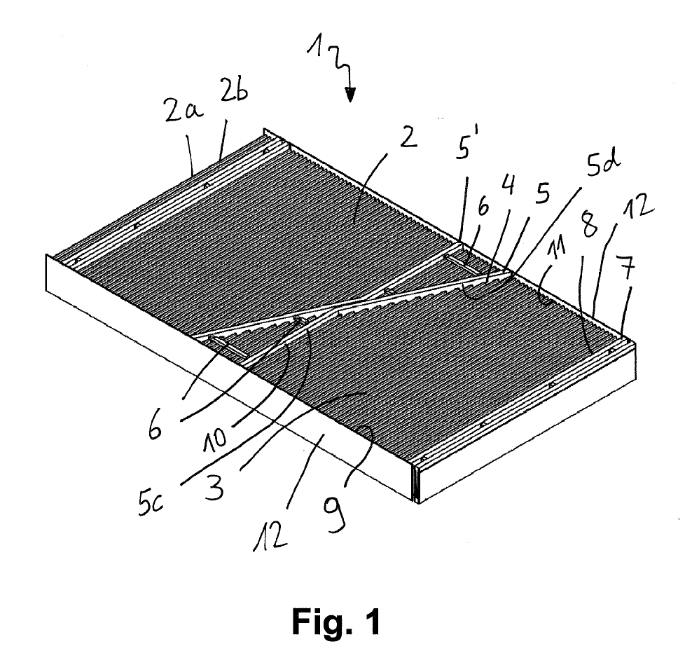

FIG. 1 shows a perspective view of a rectangular sheet 1 made of a pleated filter medium 2 from which two filter elements are produced.

Such a filter element comprises a pleated filter medium 2 with pleat valleys 2a and pleat walls 2b, wherein the filter medium 2 consists of a base body 3 and wherein the base body 3 has a first flank 4 that is reinforced by a first plastic reinforcement 5.

The first flank 4 is joined to a first plastic reinforcement 5 that accommodates pleat valleys 2a and pleat walls 2b of the filter medium 2.

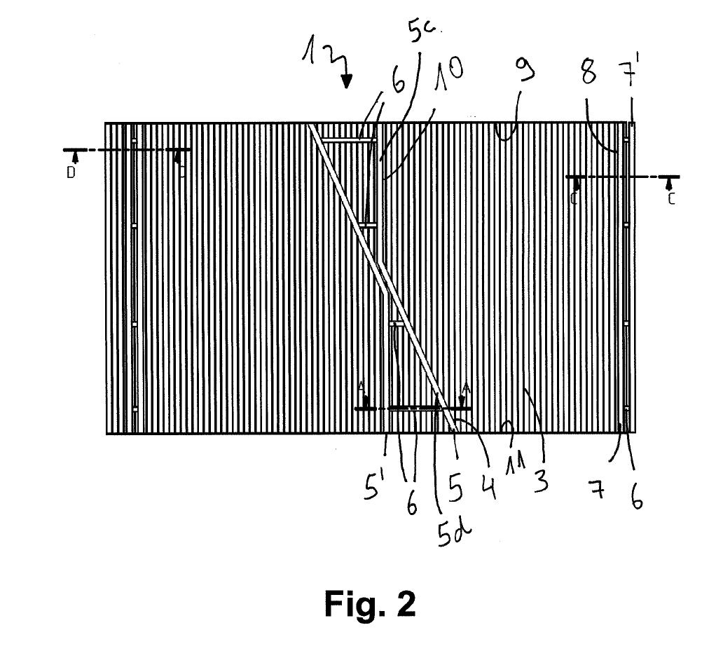

FIG. 2 shows a top view of the filter elements according to FIG. 1. The first flank 4 is configured as a slanted side.

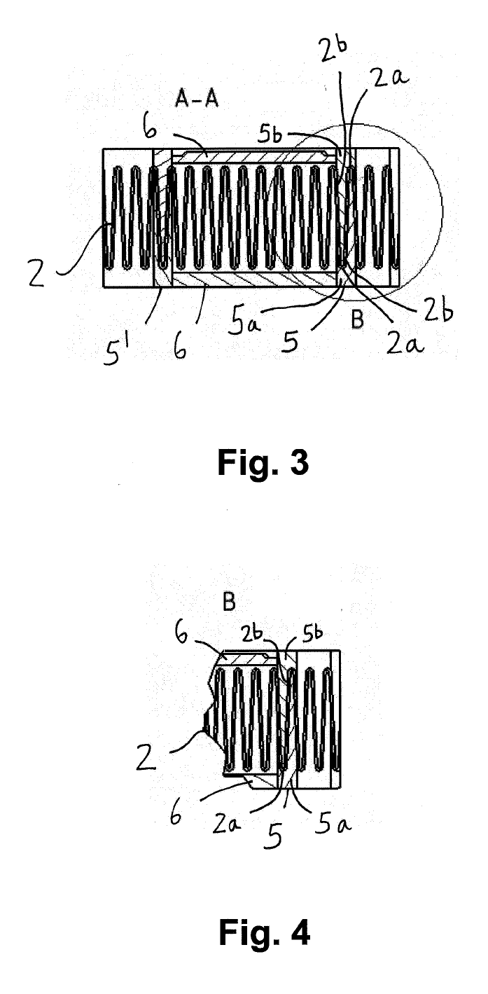

On the basis of the section along the line A-A, FIG. 3 shows that the first plastic reinforcement 5 is formed in such a way that pleat valleys 2a and pleat walls 2b fit into the plastic reinforcement 5. The first plastic reinforcement 5 consists of two inserts 5a, 5b, namely, a first insert 5a and a second insert 5b, which accommodate the pleat valleys 2a and the pleat walls 2b between them with a positive fit.

The first plastic reinforcement 5 is joined to another first plastic reinforcement 5′ via struts 6. By separating the struts 6 and cutting off the triangular segments of the filter medium 2, which are spanned by the struts 6, two filter elements are made of the sheet 1 according to FIGS. 1 and 2.

FIG. 4 is the circular section B according to FIG. 3. The first plastic reinforcement 5 consists of two inserts 5a, 5b, namely, a first insert 5a and a second insert 5b, which accommodate the pleat valleys and the pleat walls between them with a positive fit.

FIGS. 1 and 2 show that a second plastic reinforcement 7 is provided, which reinforces a second flank 8 that is at a distance from the first flank 4. The second flank 8 is configured as the base side with which the first flank 4 encloses an acute angle.

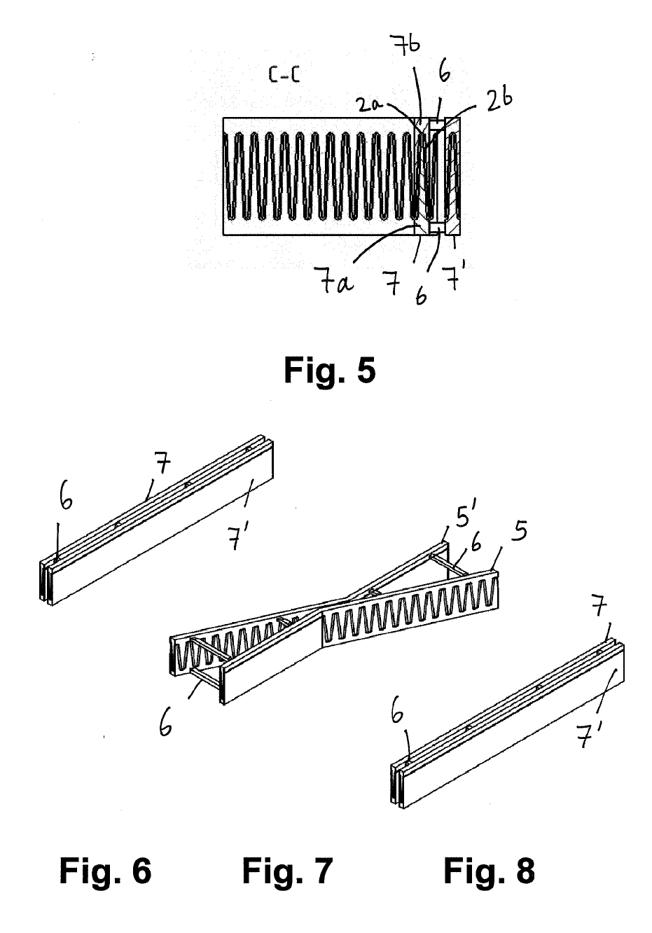

On the basis of a view of the sectional line C-C according to FIG. 2, FIG. 5 shows that the second plastic reinforcement 7 consists of two inserts 7a, 7b, namely, a third insert 7a and a fourth insert 7b, which accommodate the pleat valleys 2a and the pleat walls 2b between them with a positive fit.

The second plastic reinforcement 7 is joined to another second plastic reinforcement 7′ via the struts 6. In this manner, an additional filter element can be produced from the sheet 1 by separating the second plastic reinforcement 7 from the additional second plastic reinforcement 7′, and, although said additional filter element is not shown here, it would be adjacent on the right-hand side in FIGS. 1 and 2.

FIGS. 1 and 2 show that the filter medium 2 consists of a base body 3 with five flanks 4, 8, 9, 10, 11, and four flanks 8, 9, 10, 11 of the base body are oriented orthogonally with respect to each other, the first flank 4 opens up into two of the other flanks 10, 11, and encloses an angle that differs from a right angle with each of these two flanks 10, 11, and the first flank 4 and one of the flanks 10 into which the first flank 4 opens up are joined to the first plastic reinforcement 5. Here, the first flank 4 is configured as a slanted side. The filter element is configured as a trapezoidal filter element.

The first plastic reinforcement 5 has a section 5c that is parallel to a second flank 8 of the base body 3 as well as a section 5d that encloses an acute angle with the second flank 8.

On one flank, preferably on the second flank 8, a sealing device (not shown here) is provided that is configured in one piece with the filter element in such a way that the filter element can be inserted into a filter housing, together with the sealing device, as a unit. The filter element, with its slanted side towards the front, is inserted into the filter housing and the sealing device covers the opening of the filter housing.

Side strips 12 made of a nonwoven are arranged on the flanks 9, 11 that are not provided with a plastic reinforcement.

FIGS. 6, 7, 8 show a first and an additional first plastic reinforcement 5, 5′ as well as second and additional second plastic reinforcements 7, 7′ in a perspective view and in the sequence in which they are inserted into the sheet 1 from left to right as shown in FIG. 1 in order to create filter elements. In concrete terms, the filter elements are made by means of the following method:
providing a rectangular pleated filter medium 2 with pleat valleys 2a and pleat walls 2b,
inserting a first and a second insert 5a, 5b on onto opposite sides of the filter medium 2, wherein said inserts 5a, 5b accommodate the pleat valleys 2a and the pleat walls 2b between them with a positive fit,
fusing the inserts 5a, 5b to the filter medium 2 and cutting the filter medium 2 that has been fused to the inserts 5a, 5b away from the rest of the rectangular filter medium 2.

This method allows the production of rectangular, triangular, trapezoidal and other filter elements from a rectangular sheet 1.

Pertaining to other advantageous embodiments and refinements of the teaching according to the invention, reference is made to the general part of the description on the one hand and to the claims on the other hand.

In conclusion, it should be pointed out explicitly that the embodiment selected above serves exclusively to explain the teaching according to the invention but that the teaching is not limited to this embodiment.

While the invention has been particularly shown and described with reference to preferred embodiments thereof, it will be understood by those skilled in the art that various changes in form and details may be made therein without departing from the spirit and scope of the invention.

What is claimed is:

1: A filter element comprising:
a pleated filter medium including pleat valleys and pleat walls, the filter medium having a base body including a first flank; and
a first plastic reinforcement joined to the first flank of the pleated filter medium and accommodating the pleat valleys and pleat walls of the filter medium.

2: The filter element recited in claim 1, wherein the pleat valleys and pleat walls fit into the first plastic reinforcement.

3: The filter element recited in claim 1, wherein the first plastic reinforcement includes a first insert and a second insert, the first plastic reinforcement receiving the pleat valleys and pleat walls of the filter medium between the first and second inserts with a positive fit.

4: The filter element recited in claim 1, further comprising a second plastic reinforcement that reinforces a second flank of the filter medium at a distance from the first flank.

5: The filter element recited in claim 4, wherein the second plastic reinforcement includes a third insert and a fourth insert, the second plastic reinforcement receiving the pleat valleys and pleat walls between the third and fourth inserts with a positive fit.

6: The filter element recited in claim 1, wherein the base body has five flanks, including the first flank and four additional flanks, the four additional flanks being orthogonally oriented with respect to each other, wherein the first flank opens up into two adjacent flanks of the four additional flanks so as to enclose an angle that differs from a right angle with each of the two adjacent flanks, wherein the first flank and one of the adjacent flanks are joined to the first plastic reinforcement.

7: The filter element recited in claim 6, wherein the first plastic reinforcement includes a section that is parallel to a second flank of the base body and includes another section that encloses an acute angle with the second flank.

8: The filter element recited in claim 1, further comprising a sealing device disposed on a flank of the base body, the filter element, including the sealing device, being configured as a unit for insertion into a filter-housing.

9: The filter element recited in claim 1, wherein a side strip including a nonwoven is disposed on at least one flank of the base body that is not provided with a plastic reinforcement.

10: A method of producing a filter element, the method comprising:
providing a rectangular pleated filter medium with pleat valleys and pleat walls;
inserting a first insert and second insert on opposite sides of the filter medium so as to accommodate the pleat valleys and the pleat walls between the first and second inserts in a positive fit;
fusing the inserts to the filter medium;
cutting the filter medium fused to the inserts away from a remaining portion of the rectangular filter medium.
